(19) United States
(12) Patent Application Publication
(10) Pub. No.: US 2006/0191018 A1
(43) Pub. Date: Aug. 24, 2006

(54) Method and system for fighting the illegal distribution of protected works in a digital data transmission network

(75) Inventors: Stephane Michenaud, Puteaux (FR); Eric Petit, Houilles (FR); Jean-Hugues Royer, Paris (FR)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Co-Peer-Right Agency

(21) Appl. No.: 11/287,031

(22) Filed: Nov. 23, 2005

Related U.S. Application Data
(63) Continuation of application No. PCT/FR04/01136, filed on May 10, 2004.

(30) Foreign Application Priority Data
May 27, 2003 (FR) 03/06441

(51) Int. Cl. H04L 9/32

(52) U.S. Cl. 726/27

(57) ABSTRACT

To protect against the illegal distribution of files in peer-to-peer networks, a method includes activating simulated user terminals on several peer-to-peer networks by protection platforms connected at different points in the network, generating corrupted versions of files to be protected having features identical to those of the files to be protected, and making the corrupted versions available for sharing by means of at least one user terminal simulated by at least one of the protection platforms.

### CROSS-REFERENCE TO RELATED APPLICATIONS

This application is a continuation of International Application No. PCT/FR2004/001136, filed May 10, 2004, which was published in the English language on Dec. 9, 2004, under International Publication No. WO 2004/107704 A2, and the disclosure of which is incorporated herein by reference.

### BACKGROUND OF THE INVENTION

The present invention relates to the distribution of digital files through a data transmission network.

It applies in particular, but not exclusively, to the so-called peer-to-peer (or P2P) networks implemented in the Internet and enabling two terminals connected as a peer-to-peer network to exchange files, without going through a central server that redistributes the data. In this architecture, each terminal is configured so as to act both as server and/or client. Thus, each terminal can make files stored in its memory (hard disk) available to an unlimited number of other terminals, without using a central server.

Some so-called “centralized” peer-to-peer networks require the implementation of a central server managing a database which saves, for each user in the network, an identifier of the user associated with a list of files made available to the other users in the network. There are also so-called “decentralized” peer-to-peer networks in which the database saving the information concerning the users of the network is distributed on certain terminals of users who accept to perform this database function.

This type of network is currently very successful due to the fact that, through them and wherever they are in the world provided they are connected to such a network, the users can gratuitously obtain files containing, in particular, musical, video and software works and images that are normally protected by copyright. This illegal distribution of protected works represents a significant and increasing loss of earnings year after year for publishers.

To fight such piracy, a method involving distributing a large number of corrupted files containing incorrect data or data that do not correspond to the name or description of the file has already been considered. Indeed, the lists of files distributed include information enabling each of these files to be identified, such as the name of the file, its size, its compression rate, the connection rate of the user distributing the file, and in the case of files containing digital audio data, a sampling frequency and a listening time. Now, this information is not sufficient to determine whether a file offered in this way for downloading is correct and can be rapidly downloaded. In the specific case of a file containing a musical work, it is impossible to determine on the face of it whether this file actually contains the musical work indicated and whether the latter can be reproduced with good listening quality. Therefore, such downloading is not very reliable.

Given that the size of a file containing a musical work that is several minutes long can be several mega bytes, therefore downloading such a file can last several tens of minutes, or even several hours or several days, even with a high transmission rate. Users are thus deterred from downloading files, after having downloaded a few corrupted files. This is all the more true for video files or software programs, which are often larger in size than audio files.

To be able to locate corrupted files, it is not possible to download the files proposed by the users on a central server first to examine them before offering them for downloading, because by holding a large quantity of illegal copies, the server owner would be in breach of the law. It is also not possible either to supply information about the identity or the origin of the users offering the downloading of files, because if they were clearly identified, they could easily be sued for reproduction of copyrighted works.

However, this solution proves difficult to implement in peer-to-peer networks. Indeed, today there are many peer-to-peer networks independent from one another, based on different protocols such as OpenNap, Gnutella, FastTrack, and eDonkey. The corrupted files must therefore be distributed on each of these networks. The source code of some of these protocols is not accessible. Therefore, it is not easy to simulate a user distributing corrupted files.

Furthermore, each user of a peer-to-peer network must have an identifier in the network particularly to be able to make files available for sharing. The identifiers used to make corrupted files available for sharing can therefore be located.

Moreover, all the lists of files distributed contain a signature associated with each file, for example of SHA- or Nm5-type, such a signature being calculated on the content of the file so that if only one byte of the file is changed, the signature of the file is also changed. Therefore, the signature of the files can also be used to locate the corrupted files.

### BRIEF SUMMARY OF THE INVENTION

The present invention aims to overcome these obstacles. The present invention comprises a method for protecting files illegally distributed in peer-to-peer networks implemented, in accordance with respective peer-to-peer network protocols, by means of user terminals connected to a data transmission network and configured to function both as file client and/or server.

According to the present invention, this method includes activating simulated peer-to-peer network user terminals on several of the peer-to-peer networks by means of protection platforms connected at different points in the network. Corrupted versions of files to be protected having features identical to those of the files to be protected are generated. The corrupted versions available for sharing by means of at least one user terminal simulated by at least one of the protection platforms are made.

According to an embodiment of the present invention, this method further comprises searching, by means of at least one user terminal simulated by a protection platform, for files made available for sharing by user terminals in peer-to-peer networks and at least partially reproducing the content of files to be protected. If a file made available for sharing is found, features of the file found are obtained, a corrupted version of the file found is generated using the corresponding file to be protected and having the features of the file found, and making the corrupted version available for sharing by means of the simulated user terminals.

Advantageously, if groups are defined in the peer-to-peer network where the file made available for sharing is found, the file is downloaded by a simulated user terminal, altered and made available for sharing as it is downloaded.

Preferably, during the search for files made available for sharing by user terminals in peer-to-peer networks, a peer-to-peer network server detected as non-accessible is monitored by the simulated user terminal and as soon as it is detected as accessible again, the search for files made available for sharing is launched on the accessible peer-to-peer network server, so as to make the search more exhaustive.

According to another embodiment of the present invention, this method further comprises downloading by means of a simulated user terminal a file made available for sharing found in a user terminal, so as to limit access to the file made available for sharing by other user terminals.

Advantageously, the downloading by a simulated user terminal of a file made available for sharing found, is performed at a low speed, a fast speed being allocated to the downloading by a user terminal of a corrupted file made available for sharing by means of a user terminal simulated by a protection platform.

According to another embodiment of the present invention, the simulated user terminals are simulated in accordance with a user profile defining a geographic location of connection to the network and a daily or weekly connection schedule.

Preferably, the simulated user terminals are simulated using a user name generated randomly or selected in a targeted manner.

According to another embodiment of the present invention, an IP address of the network is allocated to each simulated user terminal, this address being periodically changed.

According to yet another embodiment of the present invention, this method comprises each protection platform receiving and processing orders for activating simulated user terminals, each simulated user terminal activation order specifying a peer-to-peer network to be accessed, a user identifier to be used to access the peer-to-peer network, and an access provider to be used to connect to the network.

The present invention also relates to a system for protecting files illegally distributed in peer-to-peer networks implemented in accordance with respective peer-to-peer network protocols by means of user terminals connected to a data transmission network and configured to function both as file client and/or server.

According to the present invention, this system comprises a plurality of protection platforms connected at different points in the network. Each of the platforms includes means for simulating user terminals of different peer-to-peer networks, means for receiving through the network and processing simulated user terminal activation orders, and means for making corrupted versions of files to be protected available for sharing in several peer-to-peer networks through the simulated user terminals.

According to an embodiment of the present invention, each protection platform comprises means for performing searches, through simulated user terminals, for files made available for sharing in the peer-to-peer networks and at least partially reproducing the content of files to be protected.

According to yet another embodiment of the present invention, each protection platform comprises means for downloading, through simulated user terminals, a piece of file made available for sharing by a group of terminals in a peer-to-peer network and at least partially reproducing the content of files to be protected, means for altering the piece of file downloaded and for making the piece of file altered available for sharing, the piece of file being altered in such a manner that a signature of the file is not changed.

According to yet another embodiment of the present invention, each protection platform comprises means for downloading, through a simulated user terminal, a file made available for sharing found in a user terminal and at least partially reproducing the content of files to be protected, so as to limit access to the file made available for sharing by other user terminals.

According to yet another embodiment of the present invention, each protection platform comprises means for downloading at low speed through a simulated user terminal, a file made available for sharing found, and means for downloading at high speed to a peer-to-peer network user terminal a corrupted file made available for sharing through a simulated user terminal.

According to yet another embodiment of the present invention, this system comprises a central database accessible through the network to the protection platforms and in which the following are stored information concerning the user terminals simulated by the protection platforms, information concerning files made available for sharing by user terminals of peer-to-peer networks and at least partially reproducing the content of files to be protected, and information concerning the files to be protected and the files made available for sharing by the platforms.

According to yet another embodiment of the present invention, this system comprises a cloning server connected to the network and designed to generate corrupted versions of the files to be protected.

According to yet another embodiment of the present invention, each protection platform comprises groups of servers connected to the network through several access providers.

According to yet another embodiment of the present invention, each protection platform comprises an interface module for accessing each peer-to-peer network in which the files to be protected must be protected.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 schematically represents a system according to the present invention, for preventing the illegal distribution of files;

FIG. 2 schematically shows the general operation of the system represented in FIG. 1;

FIG. 3 shows in the form of a flowchart the operation of an administration part of the system represented in FIG. 1;

FIG. 4 shows in the form of a flowchart the operation of a search process executed by the system represented in FIG. 1;

FIG. 5 shows in the form of a flowchart the operation of a corrupted file deployment process executed by the system represented in FIG. 1;

FIG. 6 shows in the form of a flowchart the operation of a file copying and corrupting process, executed by the system represented in FIG. 1;

FIG. 7 shows in detail a module for interfacing with a peer-to-peer network, implemented by the system represented in FIG. 1; and

FIGS. 8 and 9 schematically represent the hardware architecture of respectively automatic and manual protection platforms implemented by the system represented in FIG. 1.

### DETAILED DESCRIPTION OF THE INVENTION

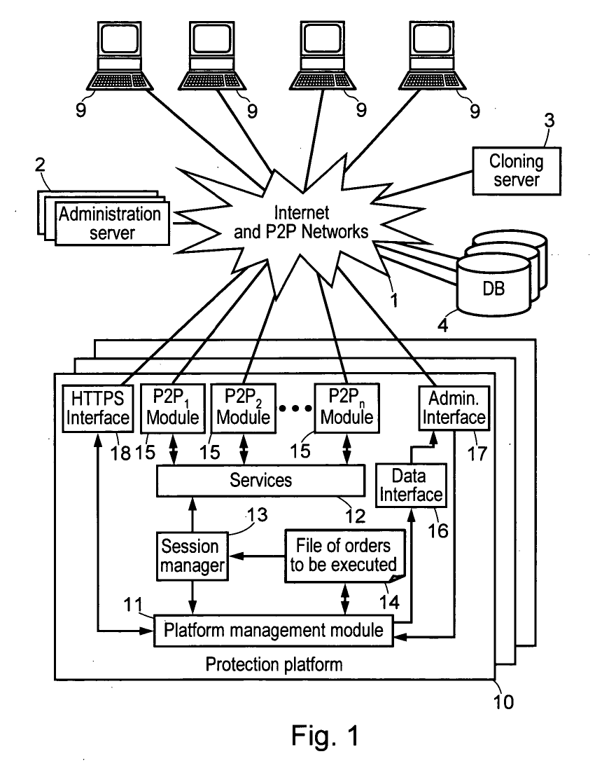

FIG. 1 represents a system enabling the illegal distribution of files in so-called “peer-to-peer” (P2P) networks to be prevented. In a P2P network, users having terminals 9 connected to a data transmission network 1, such as the Internet, can provide other users with files stored in an exchange memory area of their terminal. To do that, they must install and execute on their terminal a specific software program for sharing and downloading files, implementing a P2P network protocol used particularly to conFig. the terminal so that it functions both as file client and server in relation to the network 1 for the files that are stored in a memory area of the terminal assigned to making files available for sharing. The different user terminals 9 connected to the network 1 and executing such a software program implementing the same protocol form a P2P network.

To prevent files from being illegally distributed on such P2P networks, the system according to the present invention comprises a plurality of protection platforms 10 connected at different points in the network, administration servers 2 designed to remotely drive the protection platforms 10, a set 4 of databases and database servers accessible by the network 1 and containing all the data required for the system to function and be used, and a cloning server 3 also connected to the network 1 and enabling corrupted versions of files to be protected or files that must not be made available for sharing to be generated.

The database 4 is advantageously duplicated on several servers, each replica being synchronized with another replica so as to guarantee fast and safe access to the data at any instant, and to prevent any loss of information.

Each protection platform 10 comprises a module 11 for managing the platform, which communicates with the network 1 through an interface module 17 implementing for example the SOAP (Simple Object Access Protocol), to receive orders from administration servers 2. These orders being specified in order files 14 for example. Each platform 10 also include session management module 13 designed to start and stop sessions simulating network users, and to allocate specific tasks to the sessions, in accordance with the orders defined in the order file 14; a service module 12 grouping together, in particular, a file search service, a file distribution service, and a file download service, these services being activated by the sessions; simulation modules 15 for respectively simulating each P2P protocol and which feature each of the basic services that are required by the higher level services of the module 12; an interface module 16 for accessing the data in the database 4, and enabling the management module 11 to update the database through the interface module 17, with the information supplied by the session management module 13; and an HTTPS (Hypertext Transfer Protocol over SSL—Secure Sockets Layer) interface module 18 enabling the platform to be manually driven via a secured link from an administration terminal connected to the network 1.

A platform is therefore administrated through a network reserved exclusively for this purpose.

The orders specified in the order file 14 are advantageously written in XML (eXtensible Markup Language).

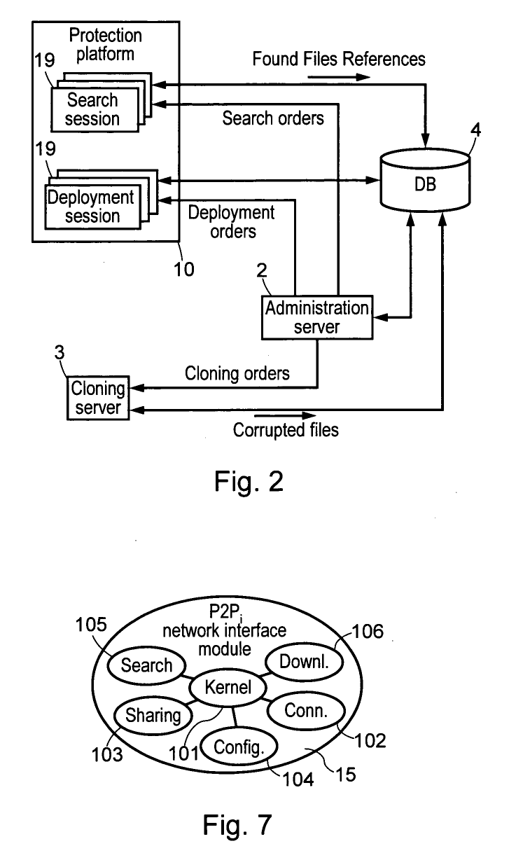

In FIG. 2, the system according to the present invention functions in the following manner. Using the information contained in the database 4, an administration server 2 defines orders for searching for, distributing or deploying, downloading and cloning, i.e. duplicating with corruption, files to be protected, and sends these orders to protection platforms 10 and to the cloning server 3. The search and deployment orders are defined in order files 14 that are respectively sent to the platforms, either through the interface 17 or through the interface 18. Upon receiving such an order file, the platform 10 that receives it activates one or more search 18 and/or deployment 19 sessions according to the orders specified in the order file 14 received.

The search sessions enable references of files that are distributed by users of a P2P network to be obtained, these file references being sent by the management module 11 to the database server 4 to save them in the database. Similarly, the information concerning the deployments that are executed by the deployment sessions are sent by the management module 11 to the database server 4.

The cloning orders contain the references of the original files to be duplicated and features of files (size, possibly signature, etc.) to be obtained. Upon receiving such an order, the cloning server 3 accesses the database 4 to obtain the original file (containing the original tape) to be duplicated and generates a corrupted file taking into account the features of files to be obtained, the corrupted file then being sent to the database 4 to be saved therein.

It will be understood that several corruption methods can be used, particularly according to the nature of the file. Thus, for example, when a file contains a musical or video work, the corruption method used can keep the first and/or last minutes of the recording intact, and change the rest of the file so as to make it unintelligible. When a file is executable (software), the duplication method used can involve changing a few bytes of the original file so as to render it non-executable.

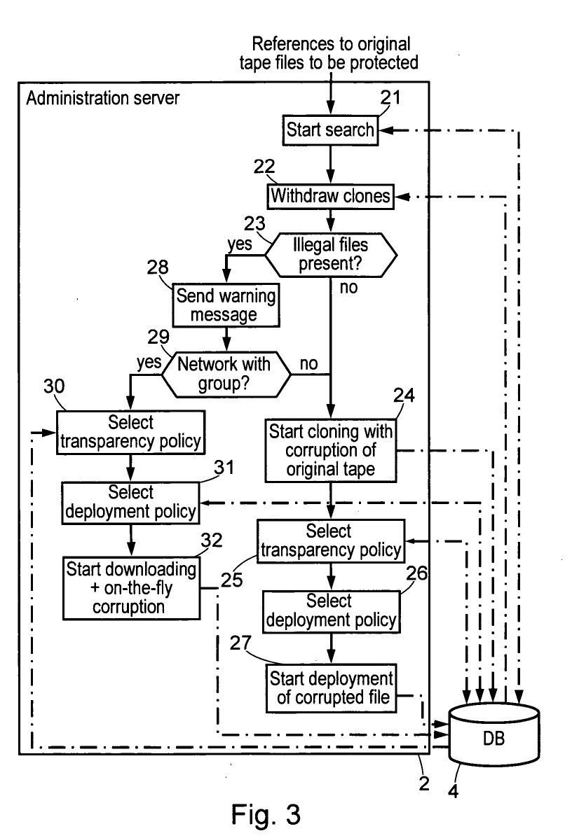

To generate the orders that are applied to the platforms 10 and to the cloning server 3, each administration server 2 operates in an automatic mode in the manner represented on FIG. 3.

The server 2 continuously consults the database 4 to detect the presence of new original tape files to be protected. For each file found, the administration server executes a step 21 of starting search sessions on different platforms 10 according to a search policy. This step involves sending search orders to the different platforms defined by the search policy.

These searches are advantageously started several times a day at random frequencies, with a view to accurately and rapidly detecting the sharing on a P2P network of new files illegally distributed and corresponding to files to be protected.

In the next step 22, the server 2 consults the database 4 in order to retrieve the lists of search results issued by the platforms 10, these lists grouping together the references and features of each file found (name of the file, title of the file, author, size of the file, format, signature of the file, name of the user who distributes it, file distribution P2P network, etc.). The names of users appearing in the lists of searches issued by the platforms 10 are constituted by any identifier enabling a user to be identified in a unique manner, such as his/her ip address for example. This information can be obtained using a tool for observing incoming and outgoing TCP/IP flows at the platforms 10.

The server 2 then analyses these lists of search results, this analysis aiming at extracting the new files found from these lists, by removing the corrupted files distributed by the platforms 10. If, at the next step 23, there are still some files in these lists, the server triggers the sending of a warning message to each user who distributes an illegal file to inform him/her of the laws in force in his/her country concerning the illegal distribution of files, and to ask him/her to remove this file from the sharing memory area of his/her terminal.

If in spite of the warning messages received, a user has not removed a file illegally made available for sharing, a bailiff can begin legal proceedings, at the request of the holders of the rights to the file illegally made available for sharing.

Certain P2P networks such as Kazaa, WinMx or eDonkey automatically form groups of users having the same file (with the same features) in their sharing memory area so as to enable a file to be downloaded in pieces, each user in the group supplying a piece of the file. When all the pieces of the file are downloaded by a network user, the P2P network software program installed on the terminal of the user groups the pieces together to reconstitute the file. In addition, when a piece of file is downloaded by a user, this piece is immediately made available for sharing and the user is integrated into the group. This arrangement improves access to the shared files and considerably increases the downloading speed, but requires the system according to the present invention to function differently.

As each downloaded piece of file is automatically put in the sharing area of the terminal as it is downloaded, the present invention provides for downloading files to be able to enter the user groups, and for corrupting the pieces downloaded on-the-fly, that is to say as they are downloaded. Thus, the other users who download the file will obtain a file having at least one corrupted part.

When in step 23 the administration server 2 detects that files are illegally distributed, the server tests the type of network on which the file is distributed (step 29) for each file. When it is a network with groups, the server chooses a transparency policy and a deployment policy (steps 31 and 32).

A transparency policy aims to prevent a platform 10 from being easily located by the P2P network users. Such a policy involves a deployment session implemented by a platform appearing on the network like an ordinary user. Such a policy thus defines the identifiers of the users in particular and the platforms to be used. The user identifiers can be generated randomly and chosen so that the users believe that they correspond to real users. They can thus be generated so as to be pronounceable by human beings and have a random length. They can also be chosen in a targeted manner, for example chosen from those used by the hackers as soon as the latter disconnect from the P2P network.

The hours of connection to the network of the users thus simulated are also chosen so as to correspond to real users. Standard profiles of simulated users are therefore defined, to which a geographic location of connection and a daily or weekly connection schedule are associated. At the same time, the idea is to ensure a permanent presence on the monitored P2P networks by multiplying the number of active sessions on the platforms 10.

Furthermore, most of the P2P protocols are capable of determining an identifier of each terminal used by the users to connect to the network. Thus, if the terminal manages several sessions of connection to the network, it is possible to determine that these sessions come from the same terminal. The transparency policy also aims to change the identifiers of the platforms, as well as the names of the file sharing directories, at a random frequency. The IP addresses used by the platforms to access the network 1 are also changed randomly.

For a transparency policy to be even more efficient, provision can be made for sharing non corrupted files, the authors of which have agreed to them being made available for sharing; these files could however be slightly altered to reduce the reproduction quality thereof.

A deployment policy determines in particular the way in which a corrupted file is distributed: which platforms, which P2P networks for each platform, and the number of sessions for each network.

In the next step 32, the server 2 sends an order for deployment with file downloading and on-the-fly corruption, to each of the platforms 10 defined by the transparency and deployment policies previously chosen.

If in step 29, new illegal files are distributed in networks without any group, or if in step 23 no illegal file is detected, the administration server 2 triggers in step 24 a cloning of the new illegal file or of the new original file to be protected so as to obtain a corrupted copy thereof, by sending a cloning order to the cloning server 3, this order containing an identifier of the file and file features (size) that the corrupted file must have. The file cloning involves creating an altered copy of the original file, the external features of which (name, size, etc. and possibly signature) are the same as those of the illegal or original file, as seen by the users, but the content of which has undergone an alteration rendering it unusable.

In the same way as for the networks with groups, the server 2 chooses a transparency policy and a deployment policy in the following steps 25, 26 for each illegal file distributed, and then in step 27, it triggers the distribution of the corrupted files generated by the cloning server 3.

More precisely, the management module 11 of each platform 10 is designed to process session creation orders, search orders, deployment and downloading orders, IP address (Internet Protocol) and host name changing orders to change an IP address or the host name used by the platform to connect to the network 1, orders for receiving files to be deployed, and orders for supplying platform 10 operation information so that a remote administration terminal can monitor the platform operation.

To be able to start search or deployment processes, a platform must first create sessions. Such processing, which is executed by the session management module 13, is triggered by the management module 11, upon receiving an order file 14 containing session creation orders specifying, for each session to be created, session activation parameters particularly specifying the P2P protocol to be used (i.e. the P2P network to which the session must be connected, an IP address mask specifying the access provider to be used by the session to connect to the network 1, the name of the user under which the session must be created, and the duration of the session).

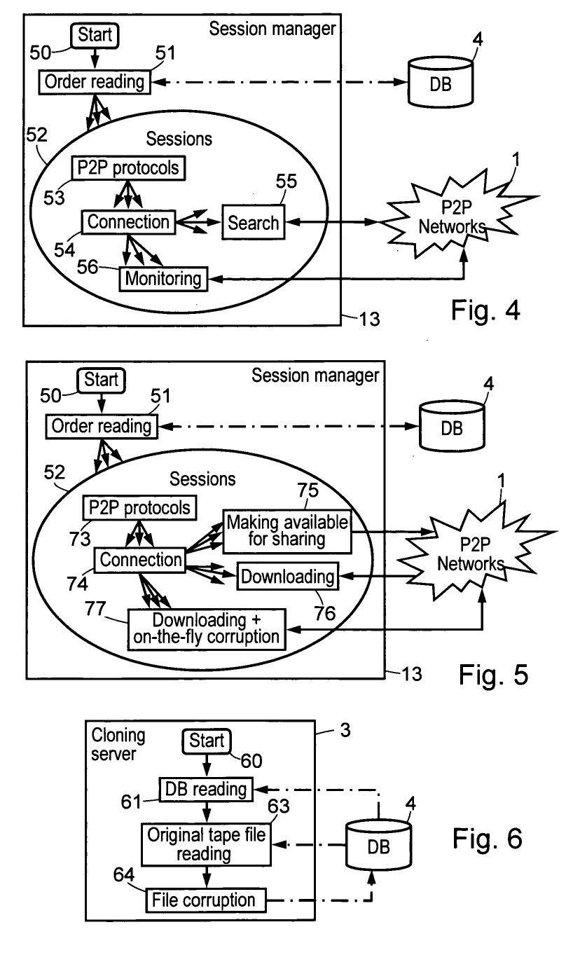

On FIG. 4 or 5, when the session management module 13 is activated by the management module 11, it executes a procedure 50 comprising a first step 51 of reading the order file 14 and of activating the sessions 52 specified in the order file, taking into account the associated activation parameters. For this purpose, the service module 12 activates the simulation module 15 corresponding to the P2P protocol to be used.

Once the session activation order has been executed, the module 11 sends the session activation information to the database 4 to inform the system of the numbers of the sessions available on the platform 10. The sessions thus activated can then be used to execute search or deployment orders.

In addition, FIG. 4 represents the tasks that are started by the module 13 after receiving a search order. A search order particularly contains the number of sessions to be allocated to the searches on the platform, and for each session used a session identifier, an indicator specifying whether or not the session must monitor the servers of the P2P network (that save the features of the network users and of the files they make available for sharing) detected as non-accessible to wait for them to connect, possibly the duration of the session and the start date of the session, key words that must be contained in the features of the files searched for and possibly search filters specifying in particular whether or not the search must be performed in networks with groups only, whether or not the search must only concern the users connected, and whether or not the search must be limited to users in certain countries.

In step 51, the module 13 reads the search order file 14, and then starts, for each session specified, using the service module 12, a search connection subtask 54 to execute the search order. Each connection subtask 54 activates a basic search task 55 for each key word to be searched for, and if the search order specifies for this session that the non-accessible servers must be monitored, it activates a basic monitoring task 56 for each non-accessible server detected. The monitoring tasks trigger a basic search task 55 as soon as a monitored server becomes accessible.

Each connection subtask 54 has a predefined lifetime to respect a transparency policy. If a search partially or totally fails, it is automatically restarted as soon as the peer-to-peer network servers are accessible again.

The location information, features and references of the files found are sent to the database server 4 by the management module 11 to be saved therein. In particular, this information groups together pieces of information about the file found, i.e. particularly its name, size, title, signature and a description of the file, and pieces of information about the user who distributes the file, i.e. his/her identifier, ip address and other pieces of information such as the date and time at which the file was found.

FIG. 5 represents sessions that are used to execute deployment orders. A deployment order contains in particular the type of deployment to be performed, the identifiers of the sessions to be used for the deployment, and for each session specified, an identifier of the files to be deployed and the bandwidth or the downloading speed allocated to the deployment. The type of deployment can be making files available for sharing, downloading files for on-the-fly corruption in the case of networks with groups, and file downloading to saturate the queues of users who make illegal files available for sharing. It is true that the main disadvantage of P2P networks for users comes from the limitation in the bandwidth available for downloads. To minimize this disadvantage, the P2P networks set up queuing systems in which the download requests of the users wait to be processed. The downloading tasks that are activated aim to saturate the download request queues, so as to reduce the number of users who can download the illegal files.

The downloading speed is advantageously chosen to be very low in the case of downloading for saturation and very high in the case of downloading for on-the-fly corruption and for making a corrupted file available for sharing. Thus, the illegal files are made quite inaccessible, and users are encouraged to download the corrupted files, which maximizes the number of users simultaneously downloading corrupted files situated in the platforms 10. After a user has started downloading a corrupted file made available for sharing, this speed is advantageously reduced as much as possible to delay the moment at which the user will realize that the file downloaded cannot be used.

In the first step 51 of the process 50, the module 13 reads the order file 14, the corrupted files to be made available for sharing in a P2P network 1 having been previously sent to the platform 10. Then, it starts the deployment tasks for the sessions specified in the order file by using the services 12.

Each session 52 used for the deployment activates a connection subtask 54 to execute the deployment order. Each connection subtask 54 activates a basic sharing task 75 if the deployment order contains a type of “making available for sharing” deployment, and/or a basic downloading task 76 if the deployment order contains a type of “downloading” deployment, and/or a basic task 77 of downloading and on-the-fly corruption if the deployment order contains such a type of deployment.

The downloading with on-the-fly corruption is performed by diverting the bit stream established between a user and the platform. This action is possible using the memory pointer of the file that is managed by the operating system. Thus, it is possible to replace a byte by another one quite transparently, so that the users who download the piece of file receive a corrupted version of it. Said replacement is done in such a manner that the signature of the file is not changed.

Thus, a user who downloads the altered piece of file from one of the platforms 10 will finally obtain a file with a corrupted part, making the file unusable.

At the end of the downloading, the file is immediately erased from the memory, and downloaded again throughout the session of downloading with on-the-fly corruption.

The downloading to saturate the queues is done to a different directory to those made available for sharing, to avoid the users of the P2P network having access to the illegal file on the platform.

All information concerning the deployment (country, platform identifier, simulated user identifiers, date, user type, network type, transparency policy, bandwidth allocated, etc.) is sent to the database 4 to be saved therein.

The deployment can also be performed manually using manual platforms 10′, in certain P2P networks that are not accessible in an automated way, particularly due to the fact that the source of the P2P network software program cannot be freely accessed.

FIG. 6 represents a cloning process 60 that is executed by the cloning server 3. In the first step 61 of this process, the cloning server 3 accesses the database 4 to obtain the references and features of the files to be duplicated and corrupted. In the next step 62, the server 3 accesses the database 4 to obtain the files containing the original tape of the files to be duplicated. In the next step 63, the server 3 generates a corrupted file for each file to be duplicated using the file containing the original tape and the features of the corrupted file to be obtained. The content and all the information concerning the corrupted files thus generated are saved in the database 4.

The cloning can involve repeating a binary sequence at the beginning of the file over the entire length of the file, or even replacing a part of the bytes of the file with others, the bytes 00 being replaced by the bytes 79 for example. This processing may also comprise a random modification of the signature of the file to prevent the corrupted files from being located by their signature.

FIG. 7 shows a P2P network user simulation module 15 in greater detail. This module comprises a software kernel 101 to which a connection module 102, a sharing module 103, a configuration module 104, a search module 105 and a download module 106 have access. These modules are specifically designed for a given P2P network 1 protocol, and adapted to the specific features of this network. Each module 15 comprises an identical interface to be able to be solicited in a same way by the services 12.

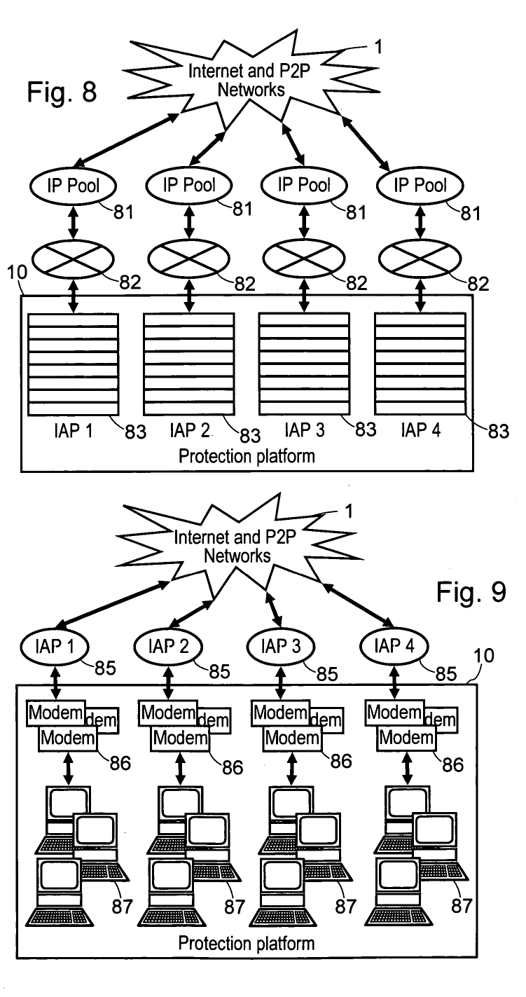

FIG. 8 represents the hardware architecture of an automatic protection platform 10. On this Fig., the platform 10 comprises several groups of servers 83, each group of servers being connected to the network 1 through an IP network 82 of respective access provider, each access provider allocating, to the group of servers 83, a set of IP addresses 81 attributable to each session simulating a P2P network user. This architecture makes it possible to randomly change access provider as part of a transparency policy.

FIG. 9 represents the hardware architecture of a manual protection platform 10. On FIG. 9, the platform 10 comprises a set of manual protection stations 87, each station being connected through a respective modem 86 to the network 1 through an access provider 85, the platform using several access providers allocating at each connection to the network 1 an IP address that is changed at each connection.

Thanks to the implementation of a database containing all the operation information collected from the protection platforms, it is possible to perform reliable and in-depth statistical analyses to determine in particular qualitative and quantitative data (data mining) about the works downloaded, and ratios concerning the downloading of corrupted files made available for sharing, with a view to improving the transparency policies allocated to the sessions.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of protecting files illegally distributed in digital data transmission networks, in accordance with peer-to-peer network protocols, by means of user terminals connected to at least one of networks and configured to function as file client and/or server, the method comprising:
activating on at least one of the networks, simulated user terminals simulated in accordance with different peer-to-peer network protocols by protection platforms connected at at least one point in the networks;
searching by means of at least one user terminal simulated by a protection platform, for files made available for sharing in the network by user terminals and at least partially reproducing content of files to be protected; and,
if a file made available for sharing is found, obtaining features of the file found as well as identification information about the user making the file found available for sharing.

2. The method according to claim 1,
wherein during the search for files made available for sharing by user terminals in the digital data transmission networks, a peer-to-peer network server detected as non-accessible is monitored by the simulated user terminal and as soon as it is detected as accessible again, the search for files made available for sharing is launched on the accessible peer-to-peer network server, so as to make the search more exhaustive.

3. The method according to claim 1, further comprising:
downloading at low speed, by means of a simulated user terminal, a file made available for sharing found in a user terminal, so as to limit access to the file made available for sharing by other user terminals.

4. The method according to claim 1,
wherein the simulated user terminals are simulated in accordance with a user profile defining a geographic location of connection to the network and a daily or weekly connection schedule.

5. The method according to claim 4,
wherein the simulated user terminals are simulated using a user name generated randomly or selected in a targeted manner.

6. The method according to claim 1,
wherein an IP address of the network is allocated to each simulated user terminal, this address being periodically changed.

7. The method according to claim 1, further comprising:
each protection platform receiving and processing orders for activating simulated user terminals, each simulated user terminal activation order specifying a peer-to-peer network protocol to be used, a user identifier, and an access provider to be used to connect to the network.

8. A system for protecting files illegally distributed in digital data transmission networks, in accordance with peer-to-peer network protocols, by means of user terminals connected to at least one of the networks and configured to function as file client and/or server, said system comprising a plurality of protection platforms connected at different points in at least one of the networks, each of the platforms comprising:
means for simulating user terminals in accordance with different peer-to-peer network protocols;
means for searching through simulated user terminals, for files made available for sharing in the network by user terminals and at least partially reproducing the content of files to be protected; and
means for obtaining information concerning each file made available for sharing found, as well as identification information about the user making available for sharing the file made available for sharing found.

9. The system according to claim 8,
wherein each protection platform further comprises means for receiving through the network and processing simulated user terminal activation orders.

10. The system according to claim 8,
wherein each protection platform comprises means for monitoring, by a simulated user terminal, a peer-to-peer network server detected as non-accessible during the search for files made available for sharing by user terminals in the digital data transmission networks, and for launching the search for files made available for sharing as soon as the server is detected as accessible again, so as to make the search more exhaustive.

11. The system according to claim 8,
wherein each protection platform comprises means for downloading at low speed through a simulated user terminal a file made available for sharing found in a user terminal and at least partially reproducing the content of files to be protected, so as to limit access to the file made available for sharing by other user terminals.

12. The system according to claim 8, further comprising:
a central database accessible through the network to the protection platforms and storing the following information:
information about the files found, made available for sharing by user terminals of peer-to-peer networks and at least partially reproducing the content of files to be protected; and
identification information about users making available for sharing files found, at least partially reproducing the content of files to be protected.

13. The system according to claim 11,
wherein said central database further stores the following information:
information about the user terminals simulated by the protection platforms;
information about the files made available for sharing by the protection platforms; and
information about the files to be protected.

14. The system according to claim 8,
wherein each protection platform comprises groups of servers connected to the network through several access providers.

15. The system according to claim 8,
wherein each protection platform comprises an interface module for accessing each peer-to-peer network in which the files to be protected must be searched for.
